(19) United States
(12) Patent Application Publication
(10) Pub. No.: US 2013/0151330 A1
(43) Pub. Date: Jun. 13, 2013

(54) METHODS AND SYSTEM FOR PREDICTING INFLUENCE-BASIS OUTCOMES IN A SOCIAL NETWORK USING DIRECTED ACYCLIC GRAPHS

(71) Applicants: Nicholas H. EVANCICH, Clarksburg, MD (US); Alexander E. Schoof, Herndon, VA (US); Grant Verstandig, Arlington, VA (US)

(72) Inventors: Nicholas H. EVANCICH, Clarksburg, MD (US); Alexander E. Schoof, Herndon, VA (US); Grant Verstandig, Arlington, VA (US)

(73) Assignee: Audax Health Solutions, Inc., Washington, DC (US)

(21) Appl. No.: 13/567,810

(22) Filed: Aug. 6, 2012

Related U.S. Application Data
(63) Continuation of application No. 13/316,057, filed on Dec. 9, 2011, now abandoned.

(51) Int. Cl. G06Q 30/02

(52) U.S. Cl. 705/14.41

(57) ABSTRACT

In some embodiments, a method includes defining a directed acyclic graph that models a social network. The directed acyclic graph can have a set of alteration nodes that collectively define a joint probability. The method also includes predicting an outcome associated with a proposed alteration with the social network based on the directed acyclic graph. The proposed alteration can be associated with an alteration node from the set of alteration nodes. The method further includes sending an indication of the outcome such that an advertising campaign for the social network includes the proposed alteration.

### BACKGROUND

Some embodiments described herein relate generally to modeling social networks, and, in particular, to methods and system for predicting influence-basis outcomes in a social network using directed acyclic graphs.

Some networks of processing elements can be modeled by directed graphs. For example, a system of probabilistic events can be modeled by a Bayesian network. In such a Bayesian network model, probabilistic events can be represented by nodes in a directed acyclic graph, and the likelihood of an event can be calculated from the likelihoods of its predecessors in the directed acyclic graph. Such a Bayesian network model has been used in health care services, such as constructing a database based on semantics and probabilistic inference related to diagnosis of diseases, or predicting development of a condition of interest in a patient. Known Bayesian networks and directed acyclic graphs, however, have not been used to model certain other types of networks or scenarios.

Accordingly, a need exists for methods and system that employs directed acyclic graphs to predict other types of networks or scenarios such as influence-basis outcomes in a social network.

### SUMMARY

In some embodiments, a method includes defining a directed acyclic graph that models a social network. The directed acyclic graph can have a set of alteration nodes that collectively define a joint probability. The method also includes predicting an outcome associated with a proposed alteration with the social network based on the directed acyclic graph. The proposed alteration can be associated with an alteration node from the set of alteration nodes. The method further includes sending an indication of the outcome such that an advertising campaign for the social network includes the proposed alteration.

### BRIEF DESCRIPTION OF THE DRAWINGS

FIG. 1 is a block diagram illustrating a predication system for a social network, according to an embodiment.

FIG. 2 is a system block diagram of a predictive engine configured to predict outcomes for a social network, according to an embodiment.

FIG. 3 is a schematic illustration of an example of a directed acyclic graph representing probabilistic events in a social network, according to an embodiment.

FIG. 4 is a flow chart illustrating a method of predicting an outcome for a proposed alteration within a social network, according to an embodiment.

FIG. 5 is a flow chart illustrating a method of predicting outcomes for multiple proposed alterations within a social network, according to another embodiment.

### DETAILED DESCRIPTION

In some embodiments, a method includes defining a directed acyclic graph that models a social network. The directed acyclic graph can have a set of alteration nodes that collectively define a joint probability. The method also includes predicting an outcome associated with a proposed alteration within the social network based on the directed acyclic graph. The proposed alteration can be associated with an alteration node from the set of alteration nodes. In some embodiments, the proposed alteration is a first proposed alteration, and the alteration node is a first alteration node. The method can include predicting an outcome associated with a second proposed alteration within the social network based on the directed acyclic graph. The second proposed alteration can be associated with a second alteration node from the set of alteration nodes, and a value for the outcome associated with the first proposed alteration can be greater than a value for the outcome associated with the second proposed alteration. In some embodiments, such a predicting operation can be performed repeatedly on the alteration nodes.

The method further includes sending an indication of the outcome such that an advertising campaign for the social network includes the proposed alteration. In some embodiments, the method can include sending the indication of the outcome to a member device associated with a member of the social network, where the member is associated with the alteration node. In some embodiments, the method can include sending the indication of the outcome to a member device associated with a member of the social network such that the member can act in a manner associated with the alteration node. In some embodiments, the advertising campaign can be associated with at least one of a product or a service associated with the proposed alteration.

In some embodiments, the method can include predicting the outcome based on a set of probability tables associated with the set of alteration nodes. In some embodiments, the probability tables can be complied in real-time (or substantially real-time) and frequently changed (e.g., constantly or substantially constantly changed). The method can further include training values of the set of probability tables before the predicting and the sending, and updating values of the set of probability tables based on the outcome and a measured outcome after the predicting and the sending. In some embodiments, the method can include calculating a probability associated with the outcome based on a set of probabilities associated with the directed acyclic graph. The set of probabilities can include a first probability associated with at least a first alteration node from the set of alteration nodes and a second probability associated with at least a second alteration node from the set of alteration nodes. In some embodiments, the predicting operation can be performed repeatedly based on the frequently-changed (e.g., constantly or substantially constantly changed) probability tables.

In some embodiments, an apparatus includes a graph module, a prediction module and a communication interface. The graph module can be configured to define a directed acyclic graph that models a social network. The directed acyclic graph can have a set of alteration nodes, each of which can have an associated probability. The prediction module can be operatively coupled to the graph module. The prediction module can be configured to predict an outcome associated with the social network based on a proposed alteration within the social network. The proposed alteration can be associated with an alteration node from the set of alteration nodes.

In some embodiments, the proposed alteration can be a first proposed alteration, and the alteration node can be a first alteration node. The prediction module can be configured to predict an outcome associated with a second proposed alteration within the social network based on the directed acyclic graph, where the second proposed alteration can be associated with a second alteration node from the set of alteration nodes. Furthermore, a value for the outcome associated with the first proposed alteration can be greater than a value for the outcome associated with the second proposed alteration. In some embodiments, the prediction module can be configured to calculate a probability associated with the outcome based on a set of probabilities associated with the directed acyclic graph. The set of probabilities can include a first probability associated with at least a first alteration node from the set of alteration nodes and a second probability associated with at least a second alteration node from the set of alteration nodes.

The communication interface can be operatively coupled to the prediction module. The communication interface can be configured to send an indication of the outcome such that an advertising campaign for the social network includes the proposed alteration. In some embodiments, the communication interface can be configured to send the indication of the outcome to a member device associated with a member of the social network, where the member is associated with the alteration node. In some embodiments, the communication interface can be configured to send the indication of the outcome to a member device associated with a member of the social network such that the member can act in a manner associated with the alteration node. In some embodiments, the advertising campaign can be associated with at least one of a product or a service associated with the proposed alteration.

In some embodiments, the prediction module can be configured to predict the outcome based on a set of probability tables associated with the set of alteration nodes. The prediction module can be configured to train values of the set of probability tables before the prediction module predicts the outcome and the communication interface sends the indication. Values of the set of probability tables can be updated based on the outcome and a measured outcome after the prediction module predicts the outcome and the communication interface sends the indication.

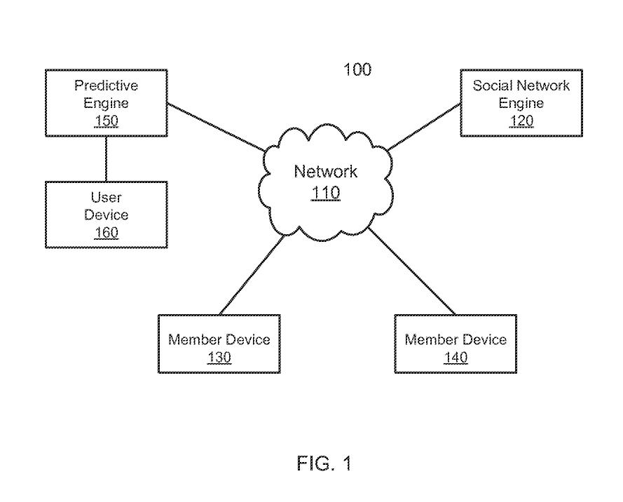

FIG. 1 is a block diagram illustrating a predication system for a social network 100, according to an embodiment. The social network 100 can include a social network engine 120 and multiple member devices, such as a member device 130 and a member device 140. The social network engine 120 can be directly coupled to a member device, or operatively coupled to a member device via a network. As shown in FIG. 1, the social network engine 120 is operatively coupled to the member devices 130 and 140 via the network 110. In some embodiments, although not shown in FIG. 1, more than two member devices can be included in such a social network 100 and coupled (directly or operatively) to the social network engine 120.

In some embodiments, a predictive engine 150 can be included in, or coupled (directly or operatively) to, the social network 100, such that data and/or information associated with the social network 100 can be retrieved from the social network engine 120 and/or the member devices 130, 140 and sent to the predictive engine 150. As a result, the predictive engine 150 can be configured to make predictions associated with the social network 100, as described in detail herein. In some embodiments, a user device 160 can be coupled to the predictive engine 150, such that a user can have an access to the prediction outcomes generated at the predictive engine 150.

In some embodiments, the social network engine 120 can include one or more hardware-based modules (e.g., a digital signal processor (DSP), a field programmable gate array (FPGA), an application specific integrated circuit (ASIC)) and/or one or more software-based modules (stored in and executed at a hardware, e.g., a module of computer code stored in memory and executed at a processor, a set of processor-readable instructions that can be executed at a processor). In some embodiments, the social network engine 120 can be hosted at or included within, for example, a computer device, a server device, or the like. In some embodiments, the social network engine 120 can be, for example, a server that runs an application associated with an online community (e.g., a forum, a BBS (bulletin board system), an email list, an online group, etc.) on the Internet. For another example, the social network engine 120 can be a server device for an online community such as Facebook, Twitter, Linkedin, or the like. In some embodiments, the social network engine 120 can be maintained and operated by, for example, a manager of the social network 100.

In some embodiments, one or more functions associated with organizing and maintaining the social network 100 can be included in one or more such modules in the social network engine 120. For example, the social network engine 120 can be configured to add a new member (e.g., a member device) into the social network 100 and/or remove an existing member (e.g., a member device) from the social network 100. For another example, the social network engine 120 can be configured to distribute a message across the social network 100 to multiple members in the social network 100, and/or collect data from members in the social network 100.

In some embodiments, the member devices 130 and 140 can be any device that can function as a communication device for a member of the social network 100. The member device 130 or 140 can be, for example, a computer, a laptop, or a smart phone used by a member of the social network 100. The user of the member device 130 or 140 can be, for example, a registered user of an online forum or BBS, a subscriber of an email list, a participant in an online group, or the like. In some embodiments, such an user can use the member device 130 or 140 to participant in activities of the social network 100, such as receiving messages from and/or sending messages to the social network engine 120 (the manager of the social network 100) and other member devices (other members), providing data and/or information of the user, communicating with other members of the social network 100, or the like.

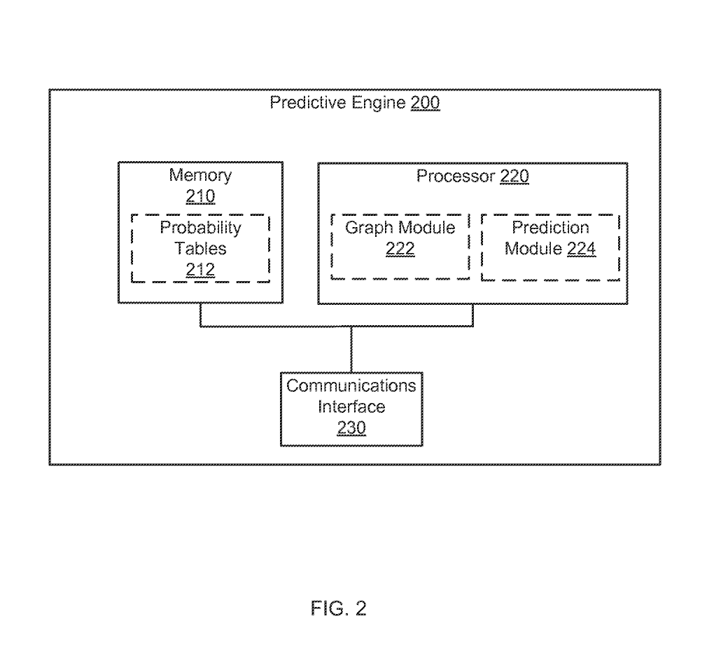

In some embodiments, the predictive engine 150 can include one or more hardware-based modules (e.g., a DSP, a FPGA, an ASIC) and/or one or more software-based modules (stored in and executed at a hardware, e.g., a module of computer code stored in memory and to be executed at a processor, a set of processor-readable instructions that can be executed at a processor). In some embodiments, the predictive engine 150 can be hosted at or included within a device capable of data collection and data processing, such as a computer, a laptop, a PDA, a server, etc. For example, the predictive engine 150 can be a server running an application that collects user data from an online forum. Details of the predictive engine 150 are further described with respect to FIG. 2.

In some embodiments, the user device 160 can be any device that can function as a communication device for a user of the predictive engine 150. Particularly, the user device 160 can provide the user access to the predictive engine 150, and make the prediction outcomes generated at the predictive engine 150 available to the user. Thus, the user can operate the predictive engine 150 to predict outcomes in the social network 100 represented by the social network engine 120 and the member devices 130, 140. Furthermore, as described in detail herein, the user can operate the predictive engine 150 (using the user device 160) to predict influence-basis outcomes associated with the social network 100.

As shown in FIG. 1, the social network engine 120, the member devices 130 and 140, and the predictive engine 150 can be operatively coupled to each other via the network 110. The network 110 can be any type of network that can connect members of the social network 100. In some embodiments, the network 110 can be a computer network such as, for example, a local area network (LAN), a wide area network (WAN), an Ethernet, the Internet, or the like.

Although shown in FIG. 1 and described herein as the social network 100 being organized over a computer network 110, in some other embodiments, a network associated with a social network can be or include in part a non-computer network. In such embodiments, the members of the social network can be connected to and communicate with each other using other communication means such as phones, mails, a bulletin board, or person-to-person meetings. As a result, a social network engine and/or member devices may not be included in a computer-based portion of such a social network. For example, the social network can be a group of pen pals that communicate with each other using mails only. For another example, the social network can be a local community where members of the community meet regularly at a physical location. In such embodiments, although without a social network engine and/or member device for such members, a predictive engine and a user device can still be used by a user to obtain prediction outcomes associated with the social network.

FIG. 2 is a system block diagram of a predictive engine 200 configured to predict outcomes for a social network, according to an embodiment. The predictive engine 200 can be structurally and functionally similar to the predictive engine 150 shown and described with respect to FIG. 1. Specifically, the predictive engine 200 can be operatively coupled to, for example, a social network engine (e.g., the social network engine 120 in FIG. 1) and/or member devices (e.g., member devices 130, 140 in FIG. 1) of a social network. The predictive engine 200 can also be coupled to a user device (e.g., the user device 160 in FIG. 1), such that the prediction outcomes generated at the predictive engine 200 can be presented to a user via the user device.

As shown in FIG. 2, the predictive engine 200 includes a processor 220, a memory 210 and a communications interface 230. The processor 220 can include a graph module 222 and a prediction module 224. The memory 210 can include probability tables 212. Furthermore, the processor 220 can be (operatively) coupled to the memory 210 and the communications interface 230. In some embodiments, the processor 220 can be configured to control operations of the communications interface 230, retrieve data from and write data into the memory 210.

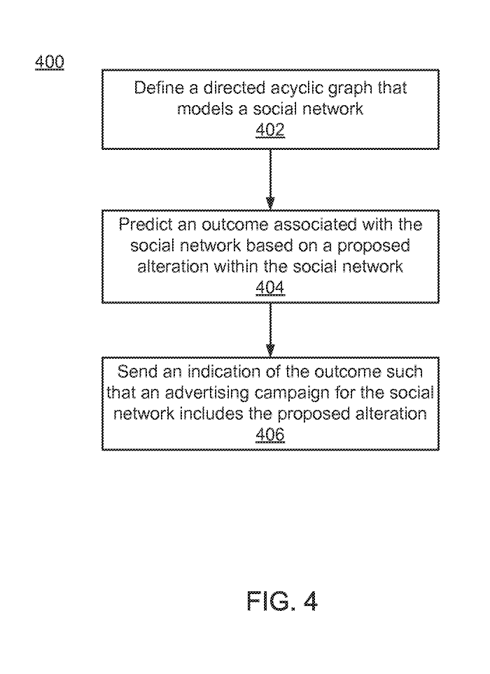

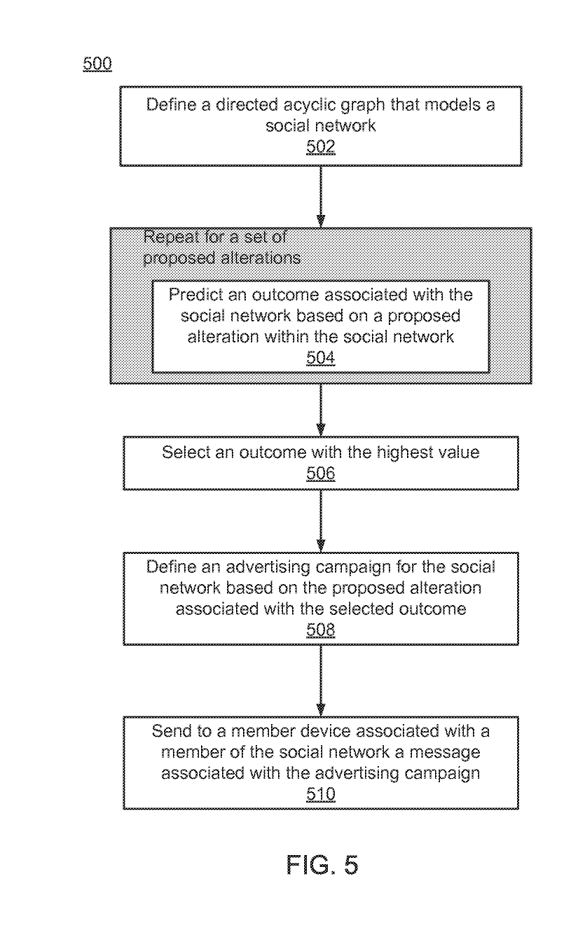

The memory 210 can be, for example, a random access memory (RAM), a memory buffer, a hard drive, a database, an erasable programmable read-only memory (EPROM), an electrically erasable read-only memory (EEPROM), a read-only memory (ROM), a flash memory, a hard disk, a floppy disk, and/or so forth. In some embodiments, as described in detail with respect to FIGS. 4 and 5, the memory 210 can store instructions to cause the processor 220 to execute modules, processes and/or functions associated with predicting influence-basis outcomes for the social network.

In some embodiments, the memory 210 of the predictive engine 200 can act as a data repository for the social network. In such embodiments, data and/or information associated with various modules, functions and/or processes of the social network can be stored in the memory 210 of the predictive engine 200. In some embodiments, probabilities associated with probabilistic events that can potentially occur in the social network can be stored in probability tables 212 within the memory 210. Such probabilistic events can include, for example, a specific message distributed across members of the social network, a particular action taken by a member of the social network, a given alteration made to a member of the social network, etc. In some other embodiments, although not shown in FIG. 2, other data and/or information associated with the social network can be stored in the memory 210 in any other suitable means of data structure.

The processor 220 can be any suitable processing device configured to run and/or execute modules associated with predicting outcomes of the social network. More specifically, as described in further detail herein, the processor 220 can be configured to execute modules, functions and/or processes to generate prediction outcomes in response to, for example, alternation of influence (e.g., probabilistic events) in the social network. In some embodiments, the processor 220 can be a general purpose processor, a FPGA, an ASIC, a DSP, and/or the like.

The graph module 222 and the prediction module 224 can be a hardware-based modules (e.g., a DSP, a FPGA, an ASIC), a software-based modules (stored in and executed at a hardware), or a combination of both. As described in further detail herein, the graph module 222 can be configured to define directed acyclic graphs that model the social network and can be used to predict influence-basis outcomes associated with the social network. The directed acyclic graphs can be defined based on probabilities stored in the probability tables 212 in the memory 210. The prediction module 224 can be configured to predict influence-basis outcomes based on the directed acyclic graphs defined at the graph module 222. More specially, the prediction module 224 can be configured to calculate the conditional probability of a certain outcome given that one or more alterations are made, or one or more probabilistic events occur, in the social network.

The communications interface 230 can be any type interface that can connect the predictive engine 200 to one or more other devices, such as a member device (e.g., the member device 130 or 140 in FIG. 1) of the social network, a social network engine (e.g., the social network engine 120 of the social network 100), and/or a user device (the user device 160 in FIG. 1). Specifically, the communications interface 230 can be used to couple the predictive engine 200 to a member device or a social network engine of the social network such that data and/or information (e.g., probabilities) associated with the social network can be collected to the predictive engine 200. Similarly, the communications interface 230 can be used to couple the predictive engine 200 to a user device such that instructions from a user can be received at the predictive engine 200 and prediction outcomes for the social network can be provided to the user via the user device. In some embodiments, the communications interface 230 can include multiple ports such that the predictive engine 200 can be coupled to more than one user device, member devices (associated with one or more social networks), and/or other devices simultaneously. In such embodiments, the predictive engine 200 can provide a prediction service for more than one social network, and/or to multiple users, at the same time.

In some embodiments, a certain probabilistic event within the social network (denoted by “resulting event” herein) can be at least partially caused by one or more other probabilistic events (denoted by “triggering events” herein) that occur in the social network. In such embodiments, the conditional probability for occurrence of the resulting event given the occurrence of the triggering events can be used to measure a level of influence those triggering events can potentially have on the outcome (i.e., the resulting event) of the social network.

In some embodiments, a directed acyclic graph can be used to model a Bayesian network that represents the causal relations among probabilistic events associated with the social network. Such a directed acyclic graph typically includes multiple nodes (or equivalently, vertices) and directed edges connecting those nodes. A node can represent a probabilistic event that can potentially occur in the social network. A directed edge connecting two nodes can represent the likelihood that a first probabilistic event (represented by the node at which the directed edge starts) causes a second probabilistic event (represented by the other node at which the directed edge ends). In some embodiments, such likelihood can be quantized by a conditional probability. That is, the directed edge can represent the conditional probability that the second probabilistic event occurs given the first probabilistic event has occurred. Additionally, in some embodiments, a probabilistic event can be referred to as an alteration on the social network, and a node in such a directed acyclic graph can be referred to as an alteration node.

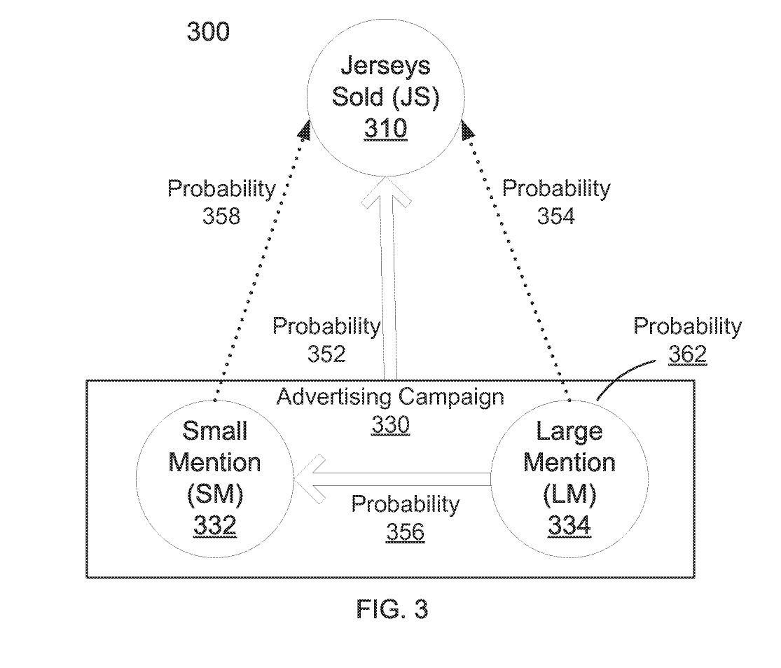

FIG. 3 illustrates an example of such a directed acyclic graph 300 that represents probabilistic events in a social network, according to an embodiment. The directed acyclic graph 300 can be defined at, for example, a graph module similar to the graph module 222 shown and described with respect to FIG. 2. The social network described by the directed acyclic graph 300 can be, for example, a cycling discussion group. An advertising campaign 330 for a specific jersey can be defined and implemented for the cycling discussion group. The advertising campaign can potentially include two strategies: the first strategy, small mention (SM) of the jersey, involves a celebrity (e.g., Lance Armstrong) well known to this cycling discussion group mentioning, in a private occasion, that the specific jersey helped him win a race; the second strategy, large mention (LM) of the jersey, involves the celebrity repeatedly mentioning, in public occasions, that the specific jersey helped him win a race. Such two strategies for the advertising campaign can be denoted by SM 332 and LM 334 in FIG. 3, respectively. Furthermore, the outcome of the two strategies (or equivalently, the influence of the two probabilistic events SM 332 and LM 334) can be measured by the number of jerseys that are sold (JS) within the cycling discussion group. The node of JS 310 in FIG. 3 represents the probabilistic event that the number of jerseys sold within the cycling discussion group is in fact substantially affected. In this example, the probabilistic events SM 332 and LM 334 are triggering events, and the probabilistic event JS 310 is a resulting event. In other words, SM 332 and LM 334 are alteration nodes, and JS 310 represents the outcome.

As shown in FIG. 3, the probability 356 represents the conditional probability of SM 332 given the value of LM 334, which can be expressed by P[SM|LM]. That is, the probability that the celebrity will or will not promote the jersey in a private occasion given that he will or will not repeatedly promote (or, has or has not repeatedly promoted) the jersey in public occasions. In this probability expression as well as other probability expressions herein, each event including SM, LM and JS can have a Boolean value of either true (i.e., T) or false (i.e., F).

Similarly, the probability 352 represents the conditional probability of JS 310 given the values of both LM 334 and SM 332, which can be expressed by P[JS|SM, LM]. That is, the probability that the number of jerseys sold is or is not substantially affected given each of the two strategies is or is not adopted. The probability 354 represents the conditional probability of JS 310 given the value of LM 334, regardless of the value of SM 332, which can be expressed by P[JS|LM]. That is, the probability that the number of jerseys sold is or is not substantially affected given the LM strategy is or is not adopted, regardless of the adoption of the SM strategy. Similarly, the probability 358 represents the conditional probability of JS 310 given the value of SM 332, regardless of the value of LM 334, which can be expressed by P[JS|SM]. That is, the probability that the number of jerseys sold is or is not substantially affected given the SM strategy is or is not adopted, regardless of the adoption of the LM strategy. Additionally, the probability 362 represents the probability associated with LM 334 (i.e., the probability that the LM strategy is adopted), which can be expressed by P[LM].

Based on the probabilities defined above, one or more probabilistic outcomes associated with the social network can be calculated. For example, the probability that the large mention strategy has a substantial effect on the sold jerseys, which can be expressed by P[JS=T|LM=T], can be calculated as described below.

P[JS=T|LM=T]=P[JS=T, LM=T]/P[JS=T];

P[JS=T]=P[JS=T, LM=T]+P[JS=T, LM=F];

PS[JS=T, LM=T]=P[JS=T|LM=T, SM=T]×P[SM=T|LM=T]×P[LM=T]+P[JS=T|LM=T, SM=F]×P[SM=F|LM=T]×P[LM=T];

PS[JS=T, LM=F]=P[JS=T|LM=F, SM=T]×P[SM=T|LM=F]×P[LM=F]+P[JS=T|LM=F, SM=F]×P[SM=F|LM=F]×P[LM=F].

Thus, given the values for P[LM], P[SM|LM] and P[JS|SM, LM], the desired probability P[JS=T|LM=T] can be calculated. In some embodiments, probability parameters that can be used to calculate probabilistic outcomes can be stored in one or more probability tables (e.g., probability tables 212 in FIG. 2). The values for P[LM], P[SM|LM] and P[JS|SM, LM] can be, for example, stored in Tables 1-3 as follows. As a result, the probability (i.e., P[JS=T|LM=T] that the large mention strategy (LM 334) has a substantial effect on the sold jerseys (JS 310) can be calculated, based on the probabilities provided in Tables 1-3, to be 0.36.

TABLE 1
(P[LM]):
LM

| T | F |
|---|---|
| 0.2 | 0.8 |

TABLE 2
(P[SM|LM]):

SM

| | | T | F |
|---|---|---|---|
| LM | F | 0.4 | 0.6 |
| | T | 0.01 | 0.99 |

TABLE 3
(P[JS|SM, LM]):

JS

| SM | LM | T | F |
|---|---|---|---|
| F | F | 0 | 1 |
| F | T | 0.8 | 0.2 |
| T | F | 0.9 | 0.1 |
| T | T | 0.99 | 0.01 |

Furthermore, although not specified here, other probabilistic outcomes associated with the social network can also be calculated in a similar way. For example, the probability (i.e., P[JS=T|SM=T] that the small mention strategy (SM 332) has a substantial effect on the sold jerseys (JS 310) can also be calculated (e.g., based on probabilities P[SM], P[LM|SM] and P[JS|SM, LM]). In some embodiments, the outcomes associated with multiple alterations in the social network can be predicted at the predictive engine. Furthermore, a value for the outcome of each alteration can be compared with a value for the outcome of each other alteration. As a result, it can be determined which alteration(s) can be included in, for example, an advertising campaign associated with the social network.

In some embodiments, the structure of the directed acyclic graph (or equivalently, the Bayesian network) can be learned from data and/or information retrieved from the social network. Similarly, parameters (e.g., in probability tables) of the directed acyclic graph can also be learned from data and/or information retrieved from the social network. Based on the learned parameters, probabilities associated with the triggering events of interest can be determined for the directed acyclic graph, and optionally stored in one or more probability tables (e.g., Tables 1-3). In some embodiments, for example, training data can be used to determine the probabilities associated with the triggering events. In such embodiments, such training data can be obtained to generate probability tables before outcomes are predicted using the probabilities from the probability tables. In some embodiments, probabilities associated with each resulting event of interest can be calculated by using, for example, a personalized or customized predictive model based on the Bayesian network, as described above.

For example, a survey can be conducted within a certain online community (e.g., a group in Linkedin, a circle of friends on Facebook) associated with a cycling discussion group to determine whether members of the cycling discussion group would like to buy a jersey after a celebrity repeatedly promotes that jersey in public occasions, or occasionally promotes that jersey in a private occasion to a member(s) of that cycling discussion group, or both. Results gathered from such a survey can be used to determine the probability parameters that are used to calculate probabilities associated with outcomes of interest. For another example, a questionnaire can be provided to a member of a certain social network (e.g., a student of a college, a member of a professional association, an employee of a company) after that member purchases a product or a service through an online shopping website (e.g., amazon.com, ebay.com). The questionnaire can be designed to retrieve information regarding factors that motivate the member to purchase the product or service. The questionnaire can include questions such as, “where did you learn this product,” “what made you choose this product over its competitors,” and/or the like. Similar to the previous example, results learned from such a questionnaire can be gathered to determine the probability parameters that are used to calculate probabilities associated with outcomes of interest. Furthermore, other suitable means (e.g., statistic methods, marketing tools, advertising strategies, etc.) can also be used to gather, retrieve or learn information and/or data that can be used to construct the directed acyclic graph and/or determine the associated parameters.

Returning to FIG. 2, after prediction outcomes resulted from alterations on the social network are calculated at the prediction module 224 based on the probabilities retrieved from the probability tables 212 and the directed acyclic graphs defined at the graph module 222, one or more alterations can be adopted for the social network based on the calculated outcomes. In some embodiments, an advertising campaign can be defined for the social network based on one or more proposed alterations within the social network. Such an advertising campaign can be associated with, for example, a product or a service. For example, as shown and described with respect to FIG. 3, the advertising campaign 330 can be associated with selling the jerseys within the cycling discussion group. For another example, an advertising campaign can be associated with selling a product (e.g., an electronic device, a computer product, a book, an apparel product) or a service (e.g., a treatment, a class, a ticket) within a certain group of customers. For yet another example, an advertising campaign can be a group deal (of a product or a service) posted on a website (e.g., groupon, livingsocial) targeted at a specific group of people.

In some embodiments, to determine which alteration(s) can be included in the advertising campaign, the influence of the multiple alteration nodes (i.e., triggering events) on an outcome (i.e., a resulting event) can be calculated and compared. As a result, the alteration(s) that has the most influence on the outcome among all the possible alterations can be determined and then included in the advertising campaign. This alteration(s) can thus be adopted for the social network. In some embodiments, other alterations are not included in the advertising campaign and thus not adopted for the social network. In some embodiments, one or more other alterations that are not the one with the most influence on the outcome can also be included in the advertising campaign, depending on the overall objective of the advertising campaign.

In the example of FIG. 3, as described above, the probability (i.e., P[JS=T|LM=T] that the large mention strategy (LM 334) has a substantial effect on the sold jerseys (JS 310) can be calculated to be, for example, 0.36. Similarly, the probability (i.e., P[JS=T|SM=T] that the small mention strategy (SM 332) has a substantial effect on the sold jerseys (JS 310) can be calculated (based on probabilities P[SM], P[LM|SM] and P[JS|SM, LM]) to be, for example, 0.25. As a result, because the influence of the large mention strategy has on the outcome is calculated to be larger than that of the small mention strategy, the advertising campaign 330 can be defined for the social network based on the large mention strategy instead of the small mention strategy. In some other embodiments, alternatively, the advertising campaign 330 can be defined for the social network based on both the large mention strategy can the small mention strategy.

In some embodiments, after an advertising campaign including one or more proposed alterations is defined at the predictive engine 200, the predictive engine 200 can be configured to send a message to a member device of the social network (e.g., via the communications interface 230), such that the proposed alterations can be implemented at a member associated with that member device. In the example of FIG. 3, a message including the advertising campaign 330 that is defined based on the large mention strategy can be sent to a member of the cycling discussion group that is in charge of selling the jerseys. In response to receiving the message, this member can be engaged in executing the large mention strategy. Alternatively, a message regarding the advertising campaign 330 can be sent to the member of the social network that is the influencer involved in the advertising campaign 330.

In some embodiments, after outcomes are predicted using probability parameters (e.g., probabilities stored in a probability table), the values of the probability parameters can be updated based on the outcomes. Similarly, after an advertising campaign including certain alterations is adopted, outcomes as a result of the advertising campaign can be measured, and the values of the probability parameters can be updated based on the outcomes. Furthermore, in some embodiments, probability tables that include probability parameters can be complied in real-time (or substantially real-time) and frequently changed (e.g., constantly or substantially constantly changed) with updated probability parameters.

In some embodiments, such an updating process can be used to generate more accurate probability parameters. Thus, new and more accurate outcomes can be predicted using the updated and more accurate probability parameters. In some embodiments, such a process of predicting outcomes, updating parameters and predicting outcomes can be iterated multiple times, until a sufficiently accurate result is generated. In some other embodiments, such a of predicting outcomes, updating parameters and predicting outcomes can be iterated without a scheduled end, depending on the objective of, for example, the advertising campaign for the social network.

In the example of FIG. 3, the probability P[JS=T|LM=T] can be calculated based on measured values of probabilities P[SM|LM] and P[JS|SM, LM], and estimated values of the probability P[LM]. After the probability P[JS=T|LM=T] is calculated, and the advertising campaign 330 including the large mention strategy is adopted, the predicted outcome (i.e., the calculated probability P[JS=T|LM=T]) can be compared with a measurement of the outcome (i.e., a measured probability P[JS=T|LM=T]). The estimated values of the probability P[LM] can be updated based on the comparison result.

FIG. 4 is a flow chart illustrating a method 400 of predicting an outcome for a proposed alteration within a social network, according to an embodiment. The method 400 can be executed by, for example, a processor of a predictive engine that is similar to the processor 220 in FIG. 2. The predictive engine (e.g., the predictive engine 150 in FIG. 1, the predictive engine 200 in FIG. 2) can be operatively coupled to a social network engine (e.g., the social network engine 120 in FIG. 1) and/or member devices (e.g., the member devices 130, 140 in FIG. 1) of the social network.

At 402, a directed acyclic graph that models the social network can be defined at, for example, a graph module (e.g., the graph module 222 in FIG. 2) within the predictive engine. In some embodiments, a node in the directed acyclic graph can represent an alteration that can be potentially made in the social network or an outcome in the social network that is a result of the alterations. A directed edge connecting two alteration nodes can represent a conditional probability of one of the two alterations causing the other alteration. Similarly, a directed edge connecting an alteration node and the outcome node can represent a conditional probability of the alteration causing the outcome. Such a directed acyclic graph can be similar to, for example, the directed acyclic graph 300 shown and described with respect to FIG. 3. In the directed acyclic graph 300, two alterations SM 332 and LM 334 can collectively have an influence on the outcome JS 310. Each of the alterations SM 332 and LM 334 can also individually have an influence on the outcome JS 310.

At 404, an outcome associated with the social network can be predicted based on a proposed alteration within the social network. Specifically, the influence of the proposed alteration on the outcome of interest can be determined at, for example, a prediction module (e.g., the prediction module 224 in FIG. 2) within the predictive engine. In some embodiments, such an influence can be measured by a conditional probability of the proposed alteration causing the outcome, which can be calculated based on the directed acyclic graph. In the example of FIG. 3, as described above, the conditional probability of the alteration LM 334 causing the outcome JS 310 (i.e., P[JS=T|LM=T]) can be calculated based on the probability 356 (i.e., P[SM|LM]), the probability 362 (i.e., P[LM]) and the probability 352 (i.e., P[JS|SM, LM]).

At 406, an indication of the outcome can be sent such that an advertising campaign for the social network includes the proposed alteration. Specifically, based on the calculated result (e.g., conditional probability) associated with the outcome and the proposed alteration, the proposed alteration can be determined to be included or not included in the advertising campaign. If the proposed alteration is determined to be included in the advertising campaign, the predictive engine can be configured to send an indication to a module where the advertising campaign is defined, such that the proposed alteration is included in the advertising campaign. Alternatively, the decision of including the alteration in the advertising campaign or not can be made outside the predictive engine. In such a scenario the predictive engine can be configured to provide the calculated result. In some embodiments, the advertising campaign can be defined at the predictive engine. In such embodiments, the indication of the outcome can be sent to the member of the social network that is the influencer included in the advertising campaign. In other embodiments, the advertising campaign can be defined at a different module.

In the example of FIG. 3, after the conditional probability associated with the outcome JS 310 and the alteration LM 334 is calculated at the prediction module, the prediction module can be configured to send the resulting conditional probability to a module (not shown in FIG. 3) where the advertising campaign 330 is defined. Based on the resulting conditional probability, the advertising campaign 330 can include or not include the alteration LM 334.

In some embodiments, outcomes associated with the social network can be predicted based on various alterations that can be potentially made to the social network. The resulted outcomes can further be compared against a desired outcome for the social network. In some embodiments, one or more parameters associated with an alteration for the social network can be manipulated and/or tuned to generate different alterations, which can potentially result in different outcomes for the social network. As a result of predicting and comparing outcomes for those various potential alterations, the alteration (including the parameters) that can result in the desired outcome (or substantially close to the desired outcome) can be determined. Thus, such an alteration can be adopted for the social network.

FIG. 5 is a flow chart illustrating a method 500 of predicting outcomes for multiple proposed alterations within a social network, according to another embodiment. The method 500 can be executed by, for example, a processor of a predictive engine that is similar to the processor 220 in FIG. 2. The predictive engine (e.g., the predictive engine 150 in FIG. 1, the predictive engine 200 in FIG. 2) can be operatively coupled to a social network engine (e.g., the social network engine 120 in FIG. 1) and/or member devices (e.g., the member devices 130, 140 in FIG. 1) of the social network.

At 502, a directed acyclic graph that models the social network can be defined at, for example, a graph module (e.g., the graph module 222 in FIG. 2) within the predictive engine. In some embodiments, a node in the directed acyclic graph can represent an alteration that can be potentially made in the social network or an outcome in the social network that is a result of the alteration. A directed edge connecting two alteration nodes can represent a conditional probability of one of the two alterations causing the other alteration. Similarly, a directed edge connecting an alteration node and the outcome node can represent a conditional probability of the alteration causing the outcome. Such a directed acyclic graph can be similar to, for example, the directed acyclic graph 300 shown and described with respect to FIG. 3. In the directed acyclic graph 300, two alterations SM 332 and LM 334 can collectively have an influence on the outcome JS 310. Each of the alterations SM 332 and LM 334 can also individually have an influence on the outcome JS 310.

At 504, an outcome associated with the social network can be predicted based on a proposed alteration from a set of proposed alterations within the social network. Such a predicting operation can be repeated for each proposed alteration from the set of proposed alterations. Specifically, for each proposed alteration from the set of proposed alterations, the influence of that proposed alteration on the outcome of interest can be determined at, for example, a prediction module (e.g., the prediction module 224 in FIG. 2) within the predictive engine. In some embodiments, such an influence can be measured by a conditional probability of the proposed alteration causing the outcome, which can be calculated based on the directed acyclic graph. Such a predicting operation can be repeated for each proposed alteration from the set of proposed alterations, such that a conditional probability is calculated for each proposed alteration.

In the example of FIG. 3, two alterations LM 334 and SM 332 are proposed for the social network (e.g., the cycling discussion group). As described above, the conditional probability of the alteration LM 334 causing the outcome JS 310 (i.e., P[JS=T|LM=T]) can be calculated based on the probability 356 (i.e., P[SM|LM]), the probability 362 (i.e., P[LM]) and the probability 352 (i.e., P[JS|SM, LM]). Similarly, the conditional probability of the alteration SM 332 causing the outcome JS 310 (i.e., P[JS=T|SM=T]) can be calculated based on the probability P[LM|SM] (not shown in FIG. 3), the probability P[SM] (not shown in FIG. 3) and the probability 352 (i.e., P[JS|SM, LM]).

At 506, an outcome with the highest value can be selected. Specifically, the proposed alterations from the set of proposed alterations can be compared against each other, and the proposed alteration with the highest conditional probability calculated previously can be selected. In the example of FIG. 3, the proposed alterations LM 334 and SM 332 can be compared. If the conditional probability for LM 334 (i.e., P[JS=T|LM=T]) is larger than that for SM 332 (i.e., P[JS=T|SM=T]), LM 334 can be selected. That is, if the influence of the large mention strategy on the sale of jerseys is larger than the influence of the small mention strategy on the sale of jerseys (or equivalently, the predicted increase in sold jerseys as a result of the large mention strategy is more than that of the small mention strategy), the large mention strategy can be selected over the small mention strategy. Otherwise, SM 332 can be selected. That is, the small mention strategy can be selected over the large mention strategy.

At 508, an advertising campaign can be defined for the social network based on the proposed alteration associated the selected outcome. In some embodiments, the advertising campaign can be defined at the prediction module or some other module within the predictive engine. In some other embodiments, the advertising campaign can be defined at another device operatively coupled to the predictive engine. In such embodiments, the predictive engine can be configured to send the selected proposed alteration to the device where the advertising campaign is defined. In the example of FIG. 3, the advertising campaign 330 can be defined (within the predictive engine or not) based on the proposed alteration LM 334 or SM 332, depending on the conditional probabilities calculated for these two alterations.

At 510, a message associated with the advertising campaign can be sent to a member device associated with a member of the social network. As a result, the proposed alteration, based on which the advertising campaign is defined, can be implemented at that member of the social network. In the example of FIG. 3, a message associated with the advertising campaign 330 can be sent to a member of the social network, such that the selected proposed alteration (LM 334 or SM 332) can be implemented at that member.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

1. A method, comprising:
defining a directed acyclic graph that models a social network, the directed acyclic graph having a plurality of alteration nodes that collectively define a joint probability;
predicting an outcome associated with a proposed alteration within the social network based on the directed acyclic graph, the proposed alteration being associated with an alteration node from the plurality of alteration nodes; and
sending an indication of the outcome such that an advertising campaign for the social network includes the proposed alteration.

2. The method of claim 1, wherein the proposed alteration is a first proposed alteration, the alteration node is a first alteration node, the method further comprising:
predicting an outcome associated with a second proposed alteration within the social network based on the directed acyclic graph, the second proposed alteration being associated with a second alteration node from the plurality of alteration nodes,
a value for the outcome associated with the first proposed alteration is greater than a value for the outcome associated with the second proposed alteration.

3. The method of claim 1, wherein the advertising campaign is associated with at least one of a product or a service associated with the proposed alteration.

4. The method of claim 1, wherein the sending includes sending the indication of the outcome to a member device associated with a member of the social network, the member being associated with the alteration node.

5. The method of claim 1, wherein the sending includes sending the indication of the outcome to a member device associated with a member of the social network such that the member acts in a manner associated with the alteration node.

6. The method of claim 1, wherein the predicting includes predicting the outcome based on a plurality of probability tables associated with the plurality of alteration nodes, the method further comprising:
training values of the plurality of probability tables before the predicting and the sending; and
updating values of the plurality of probability tables based on the outcome and a measured outcome after the predicting and the sending.

7. The method of claim 1, wherein the predicting includes calculating a probability associated with the outcome based on a plurality of probabilities associated with the directed acyclic graph, the plurality of probabilities include a first probability associated with at least a first alteration node from the plurality of alteration nodes and a second probability associated with at least a second alteration node from the plurality of alteration nodes.

8. A method, comprising:
defining a directed acyclic graph that models a social network, the directed acyclic graph having a plurality of alteration nodes that collectively define a joint probability;
predicting a first outcome associated with the social network based on a first proposed alteration within the social network, the first proposed alteration being associated with a first alteration node from the plurality of alteration nodes;
predicting a second outcome associated with the social network based on a second proposed alteration within the social network, the second proposed alteration being associated with a second alteration node from the plurality of alteration nodes, the first outcome having a value greater than a value of the second outcome; and
defining an advertising campaign for the social network based on the first proposed alteration within the social network; and
sending to a member device associated with a member of the social network a message associated with the advertising campaign, the member of the social network being associated with the first proposed alteration.

9. The method of claim 8, wherein the advertising campaign is associated with at least one of a product or a service associated with the first proposed alteration.

10. The method of claim 8, wherein the sending includes sending the indication of the outcome to the member device associated with the member such that the member acts in a manner associated with the first alteration node.

11. The method of claim 8, wherein predicting the first outcome includes predicting the first outcome based on a plurality of probability tables associated with the plurality of alteration nodes, the predicting the second outcome includes predicting the second outcome based on the plurality of probability tables, the method further comprising:
training values of the plurality of probability tables before the predicting the first outcome, the predicting the second outcome, the defining and the sending; and
updating values of the plurality of probability tables based on the first outcome and a measured outcome after the predicting the first outcome, the predicting the second outcome, the defining and the sending.

12. (canceled)

13. The method of claim 8, wherein predicting the first outcome includes calculating a probability associated with the first outcome based on a plurality of probabilities associated with the directed acyclic graph, the plurality of probabilities include a first probability associated with at least a first alteration node from the plurality of alteration nodes and a second probability associated with at least a second alteration node from the plurality of alteration nodes.

14. An apparatus, comprising:
a graph module configured to define a directed acyclic graph that models a social network, the directed acyclic graph having a plurality of alteration nodes, each alteration node from the plurality of alteration nodes having an associated probability;
a prediction module operatively coupled to the graph module, the prediction module configured to predict an outcome associated with the social network based on a proposed alteration within the social network, the proposed alteration being associated with an alteration node from the plurality of alteration nodes; and
a communication interface operatively coupled to the prediction module, the communication interface configured to send an indication of the outcome such that an advertising campaign for the social network includes the proposed alteration.

15. The apparatus of claim 14, wherein:
the proposed alteration is a first proposed alteration, the alteration node is a first alteration node,
the prediction module configured to predict an outcome associated with a second proposed alteration within the social network based on the directed acyclic graph, the second proposed alteration being associated with a second alteration node from the plurality of alteration nodes,
a value for the outcome associated with the first proposed alteration is greater than a value for the outcome associated with the second proposed alteration.

16. The apparatus of claim 14, wherein the advertising campaign is associated with at least one of a product or a service associated with the proposed alteration.

17. The apparatus of claim 14, wherein the communication interface is configured to send the indication of the outcome to a member device associated with a member of the social network, the member being associated with the alteration node.

18. The apparatus of claim 14, wherein the communication interface is configured to send the indication of the outcome to a member device associated with a member of the social network such that the member acts in a manner associated with the alteration node.

19. The apparatus of claim 14, wherein:
the prediction module is configured to predict the outcome based on a plurality of probability tables associated with the plurality of alteration nodes,
the prediction module is configured to train values of the plurality of probability tables before the prediction module predicts the outcome and the communication interface sends the indication,
values of the plurality of probability tables being updated based on the outcome and a measured outcome after the prediction module predicts the outcome and the communication interface sends the indication.

20. The apparatus of claim 14, wherein the prediction module is configured to calculate a probability associated with the outcome based on a plurality of probabilities associated with the directed acyclic graph, the plurality of probabilities include a first probability associated with at least a first alteration node from the plurality of alteration nodes and a second probability associated with at least a second alteration node from the plurality of alteration nodes.
